(19) United States
(12) Patent Application Publication
(10) Pub. No.: US 2026/0111143 A1
(43) Pub. Date: Apr. 23, 2026

(54) PROCESSING UNIT CONTROLLER IN MEMORY

(71) Applicant: Micron Technology, Inc., Boise, ID (US)

(72) Inventors: Venkata Kiran Kumar Matturi, Milpitas, CA (US); Sharath Chandra Ambula, Hyderabad (IN); Glen E. Hush, Boise, ID (US)

(21) Appl. No.: 19/363,108

(22) Filed: Oct. 20, 2025

Related U.S. Application Data
(60) Provisional application No. 63/710,105, filed on Oct. 22, 2024.

(51) Int. Cl. G06F 3/06

(52) U.S. Cl. CPC G06F 3/0655; G06F 3/0604; G06F 3/0679

(57) ABSTRACT

A processing unit (PU) controller is described herein. A memory device that includes a bank controller and the PU controller can also include a plurality of banks of memory cells. The PU controller can be coupled to the plurality of banks of memory cells. The PU controller can also comprise a PU. The bank controller can provide data from the plurality of banks to the PU controller. The PU controller can receive the data from any of the plurality of banks. The PU controller can also provide the data to the PU. The PU can perform a plurality of operations utilizing the data.

### PRIORITY INFORMATION

This application claims the benefit of U.S. Provisional Application No. 63/710,105, filed on Oct. 22, 2024, the contents of which are incorporated herein by reference.

### TECHNICAL FIELD

The present disclosure relates generally to memory, and more particularly to implementing a processing unit controller in memory.

### BACKGROUND

Memory devices are typically provided as internal, semiconductor, integrated circuits in computers or other electronic devices. There are many different types of memory including volatile and non-volatile memory. Volatile memory can require power to maintain its data and includes random-access memory (RAM), dynamic random access memory (DRAM), and synchronous dynamic random access memory (SDRAM), among others. Non-volatile memory can provide persistent data by retaining stored data when not powered and can include NAND flash memory, NOR flash memory, read only memory (ROM), Electrically Erasable Programmable ROM (EEPROM), Erasable Programmable ROM (EPROM), and resistance variable memory such as phase change random access memory (PCRAM), resistive random access memory (RRAM), and magnetoresistive random access memory (MRAM), among others.

Memory is also utilized as volatile and non-volatile data storage for a wide range of electronic applications. Non-volatile memory may be used in, for example, personal computers, portable memory sticks, digital cameras, cellular telephones, portable music players such as MP3 players, movie players, and other electronic devices. Memory cells can be arranged into arrays, with the arrays being used in memory devices.

### BRIEF DESCRIPTION OF THE DRAWINGS

FIG. 1 is a block diagram of an apparatus in the form of a computing system including a memory device in accordance with a number of embodiments of the present disclosure.

FIG. 2 is a block diagram of a processing unit controller in accordance with a number of embodiments of the present disclosure.

FIG. 3 illustrates an example flow diagram of a method for implementing a processing unit controller in memory in accordance with a number of embodiments of the present disclosure.

FIG. 4 illustrates an example machine of a computer system within which a set of instructions, for causing the machine to perform any one or more of the methodologies discussed herein, can be executed.

### DETAILED DESCRIPTION

The present disclosure implements a processing unit (PU) controller in memory. A memory device can include a plurality of banks of memory cells. A PU controller can include a PU and can be coupled to the plurality of banks of memory cells. The PU controller can receive data from any of the plurality of banks. The PU controller can provide the data to the PU. The PU can perform a plurality of operations utilizing the data.

In previous approaches, a PU can receive data from a bank of a memory device. Each bank may be coupled to a single PU and may not be coupled to the other PU's in the memory device. Each bank can provide data to the single PU and can receive data from the single PU but may not provide data to other PUs or receive data from other PUs of the memory device. In previous approaches, data that is to be provided to multiple of the PUs in the memory device is stored in each of the banks coupled to the PUs. Storing the data in each of the banks coupled to the PUs includes copying the data and storing the copied data in each of the banks. If there are sixteen banks in the memory device, then the data can be copied sixteen times and each instance of the data can be stored in a different bank. Storing copies of the data in the banks to provide to the PUs reduced the size of the banks available to store different data.

In order to address these and other deficiencies of previous approaches, embodiments of the present disclosure implement a controller, referred to as PU controller, to provide data to a PU from any of the banks of a memory device and to provide data to a bank from any of the PUs of the memory device. Implementing a PU controller to route data from the banks to the PUs and from the PUs to the banks reduces the need to store the data (e.g., copies of the data) in each of the banks. A single instance of the data can be provided to each of the PU because the PU controller can route the data stored at a single bank to each of the PUs, thereby making more of the banks available to store different data.

As used herein, a PU can include hardware and/or firmware to perform a plurality of operations. The PU can include MAC units which include hardware and/or firmware for performing a plurality of multiplication operations and a plurality of accumulation operations referred to as MAC operations.

The PU can be used to implement an artificial neural network (ANN) using the MAC units, for example. As used herein, ANNs can provide learning by forming probability weight associations between an input and an output. The probability weight associations can be provided by a plurality of nodes that comprise the ANN. The nodes together with weights, biases, and activation functions can be used to generate an output of the ANN based on the input to the ANN. A plurality of nodes of the ANN can be grouped to form layers of the ANN.

As used herein, artificial intelligence (AI) refers to the ability to improve an apparatus through “learning” such as by storing patterns and/or examples which can be utilized to take actions at a later time. Deep learning refers to a device's ability to learn from data provided as examples. Deep learning can be a subset of AI. Neural networks, among other types of networks, can be classified as deep learning. Improving the efficiency at which ANNs are executed can improve a function of a memory device executing the ANN and the function of the device in which the memory device is implemented. For example, improving the latency, power consumption, and/or throughput of the memory device implementing the ANN can cause an improvement to the latency, power consumption, and/or throughput of a memory system.

As used herein, “a number of” something refers to one or more of such things. For example, a number of memory devices can refer to one or more memory devices. A “plurality” of something intends two or more. Additionally, designators such as “N,” as used herein, particularly with respect to reference numerals in the drawings, indicates that a number of the particular feature so designated can be included with a number of embodiments of the present disclosure.

The figures herein follow a numbering convention in which the first digit or digits correspond to the drawing figure number and the remaining digits identify an element or component in the drawing. Similar elements or components between different figures may be identified by the use of similar digits. As will be appreciated, elements shown in the various embodiments herein can be added, exchanged, and/or eliminated so as to provide a number of additional embodiments of the present disclosure. In addition, the proportion and the relative scale of the elements provided in the figures are intended to illustrate various embodiments of the present disclosure and are not to be used in a limiting sense.

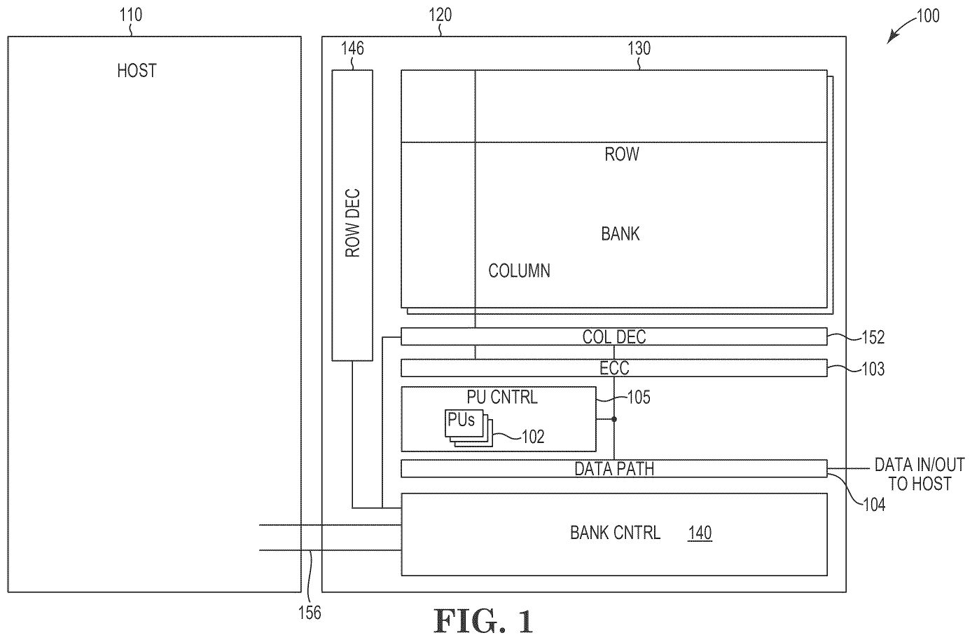

FIG. 1 is a block diagram of an apparatus in the form of a computing system 100 including a memory device 120 in accordance with a number of embodiments of the present disclosure. As used herein, a memory device 120, banks 130 of memory cells, also referred to as memory arrays 130, a host 110, the PU controller 105, and/or the PUs 102 might also be separately considered an “apparatus.”

In this example, system 100 includes a host 110 coupled to memory device 120 via an interface 156. The computing system 100 can be a personal laptop computer, a desktop computer, a digital camera, a mobile telephone, a memory card reader, or an Internet-of-Things (IoT) enabled device, among various other types of systems. Host 110 can include a number of processing resources (e.g., one or more processors, microprocessors, or some other type of controlling circuitry) capable of accessing memory 120. The system 100 can include separate integrated circuits, or both the host 110 and the memory device 120 can be on the same integrated circuit. For example, the host 110 may be a system controller of a memory system comprising multiple memory devices 120, with the system controller 110 providing access to the respective memory devices 120 by another processing resource such as a central processing unit (CPU).

In the example shown in FIG. 1, the host 110 is responsible for executing an operating system (OS) and/or various applications that can be loaded thereto (e.g., from memory device 120 via controller 140). The host 110 can provide access commands and/or security mode initialization commands to a memory device via the interface 156.

For clarity, the system 100 has been simplified to focus on features with particular relevance to the present disclosure. The memory arrays 130 can be a DRAM array, SRAM array, STT RAM array, PCRAM array, TRAM array, RRAM array, NAND flash array, and/or NOR flash array, for instance. The arrays 130 can comprise memory cells arranged in rows coupled by access lines (which may be referred to herein as word lines or select lines) and columns coupled by sense lines (which may be referred to herein as digit lines or data lines).

In various examples, the memory device 120 can include volatile memory and/or non-volatile memory. For example, the memory device 120 can be a DRAM memory device that include DRAM arrays 130. The memory device 120 can include other types of memory arrays. The memory device 120 includes address circuitry to latch address signals provided over the interface 156. The interface 156 can include, for example, a physical interface employing a suitable protocol (e.g., a data bus, an address bus, and a command bus, or a combined data/address/command bus). Such protocol may be custom or proprietary, or the interface 156 may employ a standardized protocol, such as Peripheral Component Interconnect Express (PCIe), Gen-Z, CCIX, or the like. Address signals are received and decoded by a row decoder 146 and a column decoder 152 to access the memory arrays 130. Data can be read from memory arrays 130 by sensing voltage and/or current changes on the sense lines using sensing circuitry. The sensing circuitry can comprise, for example, sense amplifiers that can read and latch a page (e.g., row) of data from the memory arrays 130. The I/O circuitry can be used for bi-directional data communication with host 110 over the interface 156. Read/write circuitry is used to write data to the memory arrays 130 or read data from the memory arrays 130.

Controller 140 decodes signals provided by the host 110. These signals can include chip enable signals, write enable signals, and address latch signals that are used to control operations performed on the memory arrays 130, including data read, data write, and data erase operations. In various embodiments, the controller 140 is responsible for executing instructions from the host 110. The controller 140 can comprise a state machine, a sequencer, and/or some other type of control circuitry, which may be implemented in the form of hardware, firmware, or software, or any combination of the three.

In various instances, the controller 140 can receive signals provided by the host 110 including signals requesting operations to be performed by the PUs 102. As used herein, the PUs 102 can include hardware, firmware, and/or software for performing operations, such as, for example, multiplication operations, using data provided by the memory arrays 130 and/or the host 110.

In various examples, error correction code (ECC) circuitry 103 can be coupled to the column decoder 152. The ECC circuitry 103 can receive data from the memory arrays 130. The ECC circuitry 103 can perform error correction operations to correct errors in data sensed from the memory arrays 130. The PUs 102 can be coupled to the ECC circuitry 102 via the PU controller 105. The PUs 102 can perform a plurality of operations on data received from the ECC circuitry 102. The PUs 102 can provide an output to the data path 104. The data path 104 can provide data to the interface 156. In various instances, the data path 104 can include Input/Output (I/O lines) and/or receivers and/or drivers. As used herein, receivers can include circuitry configured to receive a signal. Drivers can describe circuitry to drive a signal across a line or a plurality of lines.

The bank controller 140 can cause data to be read from the bank 130 and can cause data to be provided to the PU controller 105 via the sensing circuitry and the ECC 103. For example, the bank controller 140 can controller bank logic to cause the row decoders 146 to activate a row of the bank 130. The bank controller 140 can also control bank logic to cause the column decoder 146 to cause certain ones of the columns of the bank 130 to be selected. The data from the sense amplifiers coupled to the selected columns can be provided through global data lines to the ECC 103. The corrected data can be provided through global data lines to the PU controller 105. In various instances, the bank controller 140 can cause data generated by the PU controller 105 to be stored to the bank 130. For example, the PU controller 105 can place output data on the global data lines and provide a signal to the bank controller 140. The bank controller 140 can cause the data to be provided to the sensing circuitry of the bank 130 to cause the output data to be stored to the bank 130. The bank controller 140 can be different circuitry from the PU controller 105.

In various examples, the PU controller 105 can include hardware and/or firmware for distributing data provided by the banks 130 to the PUs 102. For example, the PU controller 105 can provide data from the banks 130 to any combination of the PUs 102.

Although the PUs 102 are shown as being internal to the PU controller 105, the PUs 102 can be implemented external to the PU controller 105. For example, the PU controller 105 can be coupled to each of the PUs 102 such that the PU controller 105 can provide data to each of the PUs 105. As shown, the PUs 102 can also be implemented internal to the PU controller 105. The PU controller 105 can include a conductive path to each of the PUs 102 to allow data to be provided to each of the PUs 102 from the PU controller 105.

In various examples, the PU controller 105 can determine which of the PUs 102 are to receive the data received by the PU controller 105. For instance, not all of the PUs 102 may be available to receive data from the PU controller 105. In various examples, a service agreement may dictate that only a subset of the PUs 102 can receive the data from the PU controller 105, among other considerations that can limit which of the PUs 102 receive data from the PU controller 105 at any given time. The PU controller 105 can schedule which of the available PUs 102 are to receive data. As used herein, a PU 102 is available if the PU 102 is not performing operations and/or has not been scheduled to perform operations in the future time for which the determination is being made.

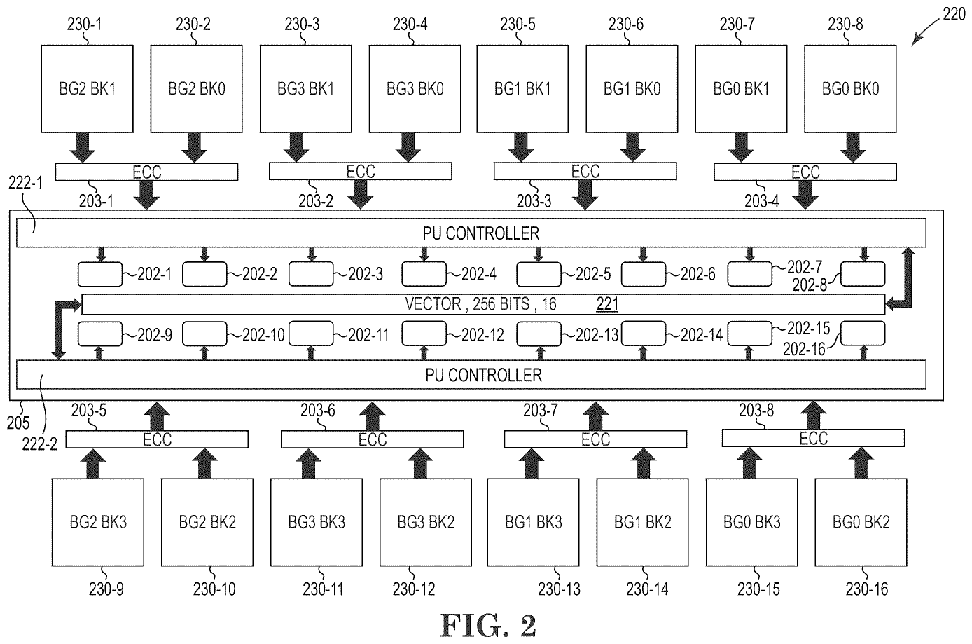

FIG. 2 is a block diagram of a PU controller 205 in accordance with a number of embodiments of the present disclosure. The PU controller 205 is shown as being integrated in the memory device 220. The memory device 220 is analogous to memory device 120 of FIG. 1.

The memory device 220 includes a plurality of banks 230-1, 230-2, 230-3, 230-4, 230-5, 230-6, 230-7, 230-8, 230-9, 230-10, 230-11, 230-12, 230-13, 230-14, 230-15, 230-16, referred to as banks 230. The banks 230 are analogous to the banks 130 of FIG. 1. The banks 230 are coupled to the ECC 203-1, 203-2, 203-3, 203-4, 203-5, 203-6, 203-7, 203-8, referred to as ECC 203 which is analogous to the ECC 103 of FIG. 1. The PU controller 205 is shown as including control circuitry 221-1, 221-2, registers 221, and PUs 202-1, 202-2, 202-3, 202-4, 202-5, 202-6, 202-7, 202-8, 202-9, 202-10, 202-11, 202-12, 202-13, 202-14, 202-15, 202-16, referred to as PUs 202. The PUs 202 are analogous to the PUs 102 of FIG. 1.

The PU controller 205 can receive data from the banks 230 and can route the data to any one or more of the PUs 202. The data can be routed without requiring that different instances of the data be stored in two or more of the banks 230.

Each of the PUs 202 can traditionally be associated with one of the banks 230. For example, the PU 202-1 can correspond to the bank 230-1. The PU 202-2 can correspond to the bank 230-2. The PU 202-3 can correspond to the bank 230-3. The PU 202-4 can correspond to the bank 230-4. The PU 202-5 can correspond to the bank 230-5. The PU 202-6 can correspond to the bank 230-6. The PU 202-7 can correspond to the bank 230-7. The PU 202-8 can correspond to the bank 230-8. The PU 202-9 can correspond to the bank 230-9. The PU 202-10 can correspond to the bank 230-10. The PU 202-11 can correspond to the bank 230-11. The PU 202-12 can correspond to the bank 230-12. The PU 202-13 can correspond to the bank 230-13. The PU 202-14 can correspond to the bank 230-14. The PU 202-15 can correspond to the bank 230-15. The PU 202-16 can correspond to the bank 230-16.

In various examples, a mode of the memory device 220 can be used to determine whether data is provided from a bank to its corresponding PU or if data is provided from any of the banks to any of the available PUs 202.

For example and based on a mode of the memory device 220, the PU controller 205 can provide data to any one or more of the PUs 202. The data can be read from any one of the banks 230. Alternatively, the data can be routed from a bank to its corresponding PU.

The banks can be organized into bank groups (e.g., BGs). For instance, the example shown in FIG. 2 includes four BGs (e.g., BG 0, BG1, BG2, and BG3), with the banks 230-7, 230-8, 230-15, and 230-16 comprising BG0, the banks 230-5, 230-6, 230-13, and 230-14 comprising BG1, the banks 230-1, 230-2, 230-9, and 230-10 comprising BG 2, and the banks 230-3, 230-4, 230-11, and 230-12 comprising BG 3.

The banks 230 can provide data to the PU controller 205 via the ECC 203. For example, the banks 230-1, 230-2 can provide data to the PU controller 205 via the ECC 203-1. The banks 230-3, 230-4 can provide data to the PU controller 205 via the ECC 203-2. The banks 230-5, 230-6 can provide data to the PU controller 205 via the ECC 203-3. The banks 230-7, 230-8 can provide data to the PU controller 205 via the ECC 203-4. The banks 230-9, 230-10 can provide data to the PU controller 205 via the ECC 203-5. The banks 230-11, 230-12 can provide data to the PU controller 205 via the ECC 203-6. The banks 230-13, 230-14 can provide data to the PU controller 205 via the ECC 203-7. The banks 230-15, 230-16 can provide data to the PU controller 205 via the ECC 203-8.

The PU controller 205 can include control logic 222-1, 222-2, referred to as control logic 222. The control logic 222 can be bank facing. For example, the control logic 222-1 can be configured to receive data from the banks 230-1, 230-2, 230-3, 230-4, 230-5, 230-6, 230-7, 230-8 and not the banks 230-9, 230-10, 230-11, 230-12, 230-13, 230-14, 230-15, 230-16 because the control logic 222-1 is physically coupled to the banks 230-1, 230-2, 230-3, 230-4, 230-5, 230-6, 230-7, 230-8 and not the banks 230-9, 230-10, 230-11, 230-12, 230-13, 230-14, 230-15, 230-16. The control logic 222-2 can be configured to receive data from the banks 230-9, 230-10, 230-11, 230-12, 230-13, 230-14, 230-15, 230-16 and not the banks 230-1, 230-2, 230-3, 230-4, 230-5, 230-6, 230-7, 230-8 because the control logic 222-1 is physically coupled to the banks 230-9, 230-10, 230-11, 230-12, 230-13, 230-14, 230-15, 230-16 and not the banks 230-1, 230-2, 230-3, 230-4, 230-5, 230-6, 230-7, 230-8.

The control logic 222 can be configured to receive the data from the banks 230 and store the data in registers 221. The registers 221 can store the data and can provide the data to the PUs 202. The data can be duplicated as it is provided to the PUs 202. For example, if the data is provided to the PU 202-1 and the PU 202-2, then a first copy of the data can be provided from the registers 221 to the PU 202-1 and a second copy of the data can be provided from the registers 221 to the PU 202-2. In various instances, the copies of data can be provided to the PUs 202 concurrently from the registers 221. Each of the PUs 202 can be coupled to the registers 221. For example, each of the PUs 202 can be coupled to the registers 221 via a plurality of lines and/or the PUs 202 can be coupled to the registers 221 via one or more buses.

The PUs 202 can perform a plurality of operations using the data received from the registers 221. The PUs 202 can generate output data. The output data can be provided to the registers 221 and stored by the registers 221. The registers 221 can provide the output data to the control logic 222 of the PU controller 205. The control logic 222 can provide the output data to the banks 230. In various instances, the same bank that provided the input data can receive the output data. In other examples, a different bank can receive the output data than provided the input data.

Although not shown, the output data generated by the PUs 202 can also be routed to the banks 230 without first storing the output data in the registers 221. For example, the output path internal to the PU controller 205 can be different than the input path internal to the PU controller 205. In various instances, the timing of the PU controller 205 can be synchronized with the timing of the memory device 220. The PU controller 205, the control logic 222, and/or the PUs 202 can receive timing signals to allow the PU controller 205 to be in synch with the memory device 220.

In various examples, the PU controller 205 can select the PUs 202 that are to receive the data provided by the banks 230. For example, the PU controller 205 can select one of the PUs 202, a subset of the PUs 202, or all of the PUs 202 (e.g., available PUs 202). The PU controller 205 can rotate the use of the PUs 202 to allow for a constant stream of data to be provided to the PUs 202. For instance, at a first time, the bank 230-1 can provide first data. The PU controller 205 can select a first number of PUs 202 and can provide the first data to the first number of PUs 202. At a second time, the bank 230-2 can provide second data. The PU controller 205 can select a second number of PUs 202 and can provide the second data to the second number of PUs 202. The first number of PUs 202 and the second number of PUs 202 can perform a number of operations concurrently for a portion of their execution. At a third time, the first number of PUs 202 can conclude the performance of the operations and can have generated first output data. The PU controller 205 can receive third data from the bank 230-1. Given that the first number of PUs 202 are available and the second number of PUs 202 are not available, the PU controller 205 can select the first number of PUs 202 and can provide the third data to the first number of PUs 202.

The PU controller 205 can select the PUs 202 based on a number of criteria. For example, the PU controller 205 can select the PUs 202 based on availability, based on a service contract, and/or based on energy consumption/availability, among other factors that can be used by the PU controller 205 to select the PUs 202.

In various examples, the PU controller 205 can facilitate the distribution of data read from a single bank 230 to multiple PUs 202. For instance, data can be provided by the bank 230-16 to the PU controller 205. The PU controller 205 can store the data in the registers 221. The data can be distributed from the registers 221 to the PUs 202-5, 202-6, 202-13, 202-14. Each of the PUs 202-5, 202-6, 202-13, 202-14 can receive a different copy of the data stored in the registers 221. The control logic 222 can provide signals to the registers 221 to cause the charge stored in the registers 221 to be duplicated and provided to the PUs 202-5, 202-6, 202-13, 202-14. The control logic 222 can provide signals to the PUs 202-5, 202-6, 202-13, 202-14 to cause the PUs 202-5, 202-6, 202-13, 202-14 to store the data and perform a plurality of operations using the data.

The output data generated by the PUs 202-5, 202-6, 202-13, 202-14 can be provided to the bank 230-16 or a different bank such as bank 230-4. The PUs selected by the PU controller 205 to receive data can be consecutive PUs and/or non-consecutive PUs. Consecutive PUs include PUs that are adjacent PUs. Non-consecutive PUs include non-adjacent PUs. The control logic 222 can provide signals to the PUs 202-5, 202-6, 202-13, 202-14 to cause the output data to be provided from the PUs 202-5, 202-6, 202-13, 202-14 to the registers 221 for storage. The control logic 222 can provide signals to the registers 221 to cause the registers 221 to provide the output data to the control logic 222. The control logic 222 can route the output data to the bank 230-16 or a different bank.

In various examples, the PU controller 205 can facilitate the distribution of data read from the multiple banks 230 to a single PU from the PUs 202. For instance, data can be provided by the banks 230-16, 230-8 to the PU controller 205. The PU controller 205 can store the data in the registers 221. The data can be distributed from the registers 221 to the PU 202-1. The control logic 222 can provide signals to the registers 221 to cause the charge stored in the registers 221 to be provided to the PU 202-1. The control logic 222 can provide signals to the PU 202-1 to cause the PU 202-1 to store the data and perform a plurality of operations using the data.

The output data generated by the PU 202-1 can be provided to the banks 230-16, 230-8 or different banks such as banks 230-2, 230-3. The banks configured to receive the output data can be consecutive banks and/or non-consecutive banks. Consecutive banks include banks that are adjacent banks (e.g., the banks 230-11, 230-12). Non-consecutive banks include non-adjacent banks (e.g., the banks 230-7, 230-9). The control logic 222 can provide signals to the PU 202-1 to cause the output data to be provided from the PU 202-1 to the registers 221 for storage. The control logic 222 can provide signals to the registers 221 to cause the registers 221 to provide the output data to the control logic 222. The control logic 222 can route the output data to the banks 230-16, 230-8 or different banks.

In various examples, the PU controller 205 can facilitate the distribution of data read from the multiple banks 230 to multiple PUs 202. For instance, data can be provided by the banks 230-16, 230-8 to the PU controller 205. The PU controller 205 can store the data in the registers 221. The data can be distributed from the registers 221 to the PUs 202-11, 202-12, 202-16. The control logic 222 can provide signals to the registers 221 to cause the charge stored in the registers 221 to be provided to the PUs 202-11, 202-12, 202-16. The control logic 222 can provide signals to the PUs 202-11, 202-12, 202-16 to cause the PUs 202-11, 202-12, 202-16 to perform a plurality of operations using the data.

The output data generated by the PUs 202-11, 202-12, 202-16 can be provided to the banks 230-16, 230-8 or different banks 230-2, 230-3. The control logic 222 can provide signals to the PUs 202-11, 202-12, 202-16 to cause the output data to be provided from the PUs 202-11, 202-12, 202-16 to the registers 221 for storage. The control logic 222 can provide signals to the registers 221 to cause the registers 221 to provide the output data to the control logic 222. The control logic 222 can route the output data to the banks 230-16, 230-8 or different banks.

As described herein the mapping from the banks 230 to the PUs 202 can occur in two stages. In a first stage data can be received from and/or provided to one or more blocks. In a second stage data can be received from or stored in the registers 221. The mapping can include the receipt of the data from the banks 230 and/or the providing of the data to the banks 230. The PU controller 205 can be configured to provide data to each of the banks 230 or receive data from each of the banks 230. The PU controller 205 can be coupled to each of the banks 230. For example, the PU controller 205 can be coupled to the banks 230 through one or more global data lines. The mapping can also include the providing of the data to the PUs 202. The data can be provided from the registers 221 to the PUs 202. Each of the PUs 202 can be coupled to the registers 221. The receipt of the data through the control logic 222 and the providing of data through the registers 221 can define the routing of data from banks 230 to PUs 202 or the routing of data from the PUs 202 to the banks 230.

In various examples, the memory controller of a host can provide processing-in-memory (PIM) commands to the memory device. The memory device can provide the PIM commands to the PU controller 205. The PIM commands can be provided as matrix addresses and/or vector addresses. For example, the memory controller can provide a matrix address to the memory device. The memory device can interpret the matrix address as a PIM command. The memory device can provide the PIM command to the PU controller 205. Alternatively, the matrix address can be provided directly to the PU controller 205 and the PU controller can convert the matrix address to a PIM command. The matrix address can have a 32*read burst length (RDBL) 16. The matrix address can have a length equal to 16 RDBL multiplied by 32. The vector address can have a length equal to one RDBL 16.

The matrix address and the vector address can be used to access data from the banks 202. For example, the matrix address can include a bank address, a row address, and/or a column address. Although a single bank address, row address, and/or column address is described, the matrix address can include multiple bank addresses, multiple row addresses, and/or multiple column addresses. The vector address can also include a bank address, a row address, and/or a column address.

Once the PU controller 205 receives the PIM command in the form of a matrix address and/or a vector address, the PU controller 205 can generate an access command to read the matrix data and/or vector data from one or more of the banks 230. The access command can be executed by the memory device 220 to cause the memory device 220 to access the matrix data and/or the vector data. The matrix data and/or the vector data can be read from the banks 230 and can be provided to the PU controller 205. The PU controller 205 can provide the matrix data and/or the vector data to the PUs 202 as previously described. The PU controller 205 can also generate access commands (e.g., write command) to cause the output data generated by the PUs 202 to be stored back to the banks 230. In various instances, the output data generated by the PUs 202 can also be provided to the host via input/output circuitry (I/O) of the memory device 220.

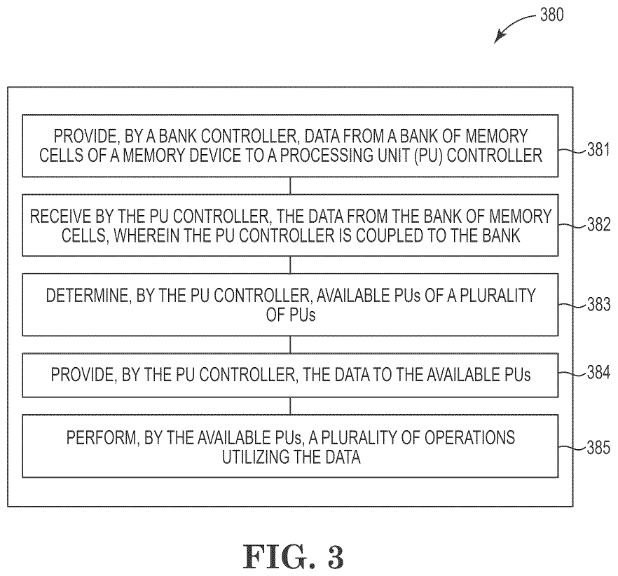

FIG. 3 illustrates an example flow diagram of a method 380 for implementing a processing unit controller in memory in accordance with a number of embodiments of the present disclosure. The method can be executed by a memory device of a computing system. For example, the method can be executed by a PU controller or a PU of the memory device. The method 380 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 380 is performed by the memory controller 105 of FIG. 1 and the memory controller 205 of FIG. 2. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At 381, a bank controller (e.g., the bank controller 140) of FIG. 1) can provide data from a bank of memory cells to the PU controller. For example, the bank controller can cause data to be sensed from the bank of memory cells and transferred to global data lines via the sensing circuitry of the bank. The PU controller can receive the data through the global data lines.

At 382, a PU controller (e.g., the PU controller 105 of FIG. 1 and the PU controller 205 of FIG. 2) can receive data from a bank (e.g., the banks 130 of FIG. 1 and the banks 230 of FIG. 2) of memory cells. The PU controller can be coupled to the bank of memory cells. For example, the bank can provide data to ECC (e.g., ECC 103 of FIG. 1 and ECC 203 of FIG. 2) via sensing circuitry of the bank. The ECC can provide the data to the PU controller. The PU controller can be indirectly coupled to the bank via the ECC.

At 383, the PU controller can determine available PUs of the plurality of PUs. The PUs may be unavailable for a variety of reasons. For example, a portion of the plurality of PUs may be unavailable because the portion of the plurality of PUs are being executed to perform a plurality of operations. In various instances, the unavailable PUs may be concurrently executing a plurality of operations.

However, the unavailable PUs can be executed independently of each other and the available PUs. For instance, a first portion of the unavailable PUs can begin execution at a first time, a second portion of the unavailable PUs can begin execution at a second time, and a third portion of the unavailable PUs can begin execution at a third time. Between a third time and a fourth time, the first portion, the second portion, and the third portion of the unavailable PUs can be executed concurrently. The first portion of the unavailable PUs can conclude execution at the fourth time, the second portion of the unavailable PUs can conclude execution at a fifth time, and the third portion of the unavailable PUs can conclude execution at a sixth time. The execution of the first portion does not depend on the execution of the second portion and the third portion. The execution of the second portion does not depend on the execution of the first portion and the third portion. The execution of the third portion does not depend on the execution of the first portion and the second portion. Any of the first portion, the second portion, and the third portion can be executed without the execution of any of the other portions.

At 384, the PU controller can provide the data to the available PUs. For example, the PU controller can store the data in registers of the PU controller. The registers of the PU controller can provide copies of the data to the available PUs.

At 385, the available PUs can perform a plurality of operations utilizing the data. In various examples, the available PUs that perform the plurality of operations may become unavailable once they begin performing the plurality of operations. The available PUs that perform the plurality of operations may not be independent from each other. The available PUs may be dependent given that they are executing the plurality of operations at the same time and given that the data used to perform the plurality of operations is the same data or given that the data is associated with the same ANN.

The plurality of PUs can be coupled to the PU controller. The PU controller can provide the data to the available PUs by providing the data externally to the PU controller. In such implementations, the PU controller may control the PUs even though the PUs are not part of the PU controller and are implemented external to the PU controller.

The PU controller can include registers. The data received from the bank can be stored in the registers prior to providing the data from the registers to the plurality of PUs. The data can be provided from the registers to the plurality of PUs regardless of whether the plurality of PUs are implemented internal to the PU controller or external to the PU controller. For example, the PU controller can provide the data internally from the registers to the available PUs if the plurality of PUs are implemented internal to the PU controller.

The data can be provided to the available PUs sequentially or concurrently. For example, the data can be provided from the registers to the available PUs at the same time. The data can be provided as signals via a plurality of lines. The available PUs can store the signals at relatively the same time. The data can be provided to the registers sequentially. For instance, the data can be provided to a first available PU followed by providing the data to a second available PU. The second available PU may not receive the data until after the first available PU has received the data. The first available PU may begin execution after receipt of the data or may defer execution until the second available PU is ready to being execution of a plurality of operations utilizing the same data.

The available PUs can provide output data generated by each of the available PUs to the bank concurrently. For example, first output data generated by a first PU and second output data generated by a second PU can be stored in the registers can be provided from the registers to the bank concurrently. As described herein concurrence describes an act occurring at relatively the same time.

Although not shown in FIG. 2, the PU controller can include input registers (e.g., registers 221) and output registers. The input registers can be utilized to store data received by the PU controller. The output registers can be utilized to store output data generated by the PUs. Implementing input registers and output registers in the PU controller allows the PU controller to receive and output data at the same time.

The output data stored in the output registers can be provided to the bank sequentially. For example, first output data generated by a first PU can be provided by the output registers to the bank before second output data generated by a second PU is provided by the output registers to the bank.

A first portion of the output data stored in the output registers can be provided to the bank. A second portion of the output data stored in the output registers can be provided to a system-on-chip (SOC) coupled to the memory device that includes the bank of memory cells, the PU controller, and the plurality of PUs. For example, the PU controller can be coupled to input/output circuitry of the memory device such that the PU controller can provide data externally to the memory device.

In various examples, a bank controller can provide data from a plurality of banks to a PU controller. The PU controller (e.g., the PU controller 105 of FIG. 1 and the PU controller 205 of FIG. 2) can receive data from any of the plurality of banks (e.g., the banks 130 of FIG. 1 and the banks 230 of FIG. 2). The plurality of banks can comprise memory cells. The PU controller can be coupled to the plurality of banks of memory cells. The PU controller can comprise a PU (e.g., the PUs 202 of FIG. 2). The PU controller can be configured to receive data from each of the plurality of banks of memory cells. The data can comprise matrix data and/or vector data. The data can be used to implement an ANN. The data can also be used to execute an ANN. For example, the data comprising matrix data and/or vector data can include input data to an ANN and weights of the ANN. The PU of the PU controller can perform multiplications using the matrix data and the vector to process the input data through an ANN to generate an output to the ANN.

The PU controller can provide the data to the PU. The PU controller can route the data provided by a first bank of the plurality of banks to the PU at a first time. At a second time, the PU controller can route the data provided by a second bank of the plurality of banks to the PU. The PU controller can route the data from a bank to the PU even if the PU does not correspond to the bank. For example, in a traditional architecture each PU can be implemented to process data from an associated bank and not other banks. The PU can be described as corresponding to the bank given that the PU routes data from the bank and not other banks. The PU controller can be implemented to route data from the other banks and the bank to the PU thereby allowing the memory device to utilize PU resources more efficiently than limiting the PU to process data provided by a single bank.

A PU can perform a plurality of operations utilizing the data. For example, first data provided by a first bank can be stored in a first register of the PU. Second data provided by a second bank can be provided along with the first data to one or more MAC units of the PU. The MAC units can perform a plurality of multiplication operations using the matrix data and the vector data to execute an ANN. The output of the MAC units can be accumulated. The accumulated results can be an output of a layer of the ANN and/or an output of the ANN. In various examples, the output of the PU can be provided to different PUs, can be stored in the plurality of banks, and/or can be provided externally to the memory device.

A first bank of memory cells, of the plurality of banks of memory cells, can provide first data to the PU controller. The PU controller can provide the first data to the PU by routing the first data to the PU. The PU can be indirectly coupled to the plurality of banks of memory cells through the PU controller. The PU controller can route matrix data from a first bank and vector data from a second bank of the plurality of banks.

The PU controller can provide output data generated by the PU utilizing the first data to the first bank for storage. For example, the PU can provide the output data to the control logic of the PU controller. The control logic of the PU controller can provide the output data to the first bank for storage.

A second bank of memory cells of the plurality of banks of memory cells can provide second data to the PU controller. In various examples, the second bank and the first bank of memory cells can provide data to the PU controller concurrently. For example, first control logic of the PU controller can receive first data from the first bank. Second control logic of the PU controller can receive second data from the second bank concurrently with the receipt of the first data by the first control logic. The first control logic and the second control logic can store the first data and the second data concurrently in registers of the PU controller and/or can store the first data and the second data sequentially in the registers of the PU controller.

The PU controller can provide the second data to the PU subsequent to providing the first data to the PU. For example, the PU can receive the first data and the second data from the registers. The registers can provide the first data to the PU after which the registers can provide the second data to the PU.

The PU controller can provide output data generated by the PU utilizing the second data to the first bank for storage. The PU controller can also provide output data generated by the PU utilizing the first data to the second bank for storage. The outputs generated by the PU can be provided to any of the plurality of banks.

In various examples, an apparatus can include a plurality of banks of memory cells, a PU controller, and a bank controller. The bank controller can provide data from a plurality of banks to the PU controller. The PU controller can be coupled to the plurality of banks of memory cells. The PU controller can comprise a plurality of PUs. The controller can receive data from any of the plurality of banks. The PU controller can determine available PUs of a plurality of PUs. The PU controller can provide the data to the available PUs. The available PUs can perform a plurality of operations utilizing the data.

The PU controller can provide output data generated by the plurality of operations from the available PUs to the plurality of banks. The PU controller can also provide first data, from the data received from a first bank of the plurality of banks, to a first available PU from the available PUs. The PU controller can also perform a first plurality of operations utilizing the first data to generate first output data. The PU controller can provide second data, from the data received from a second bank of the plurality of banks, to a second available PU from the available PUs.

The PU controller can perform a second plurality of operations utilizing the second data to generate second output data. The PU controller can provide the first output data from the first available PU to the second bank. The PU controller can also provide the second output data from the second available PU to the first output bank. The PU controller is not limiting to providing output data to a bank that provide input data used to generate the output data. The PU controller can provide output data to a bank that did not provide input data used to generate the output data.

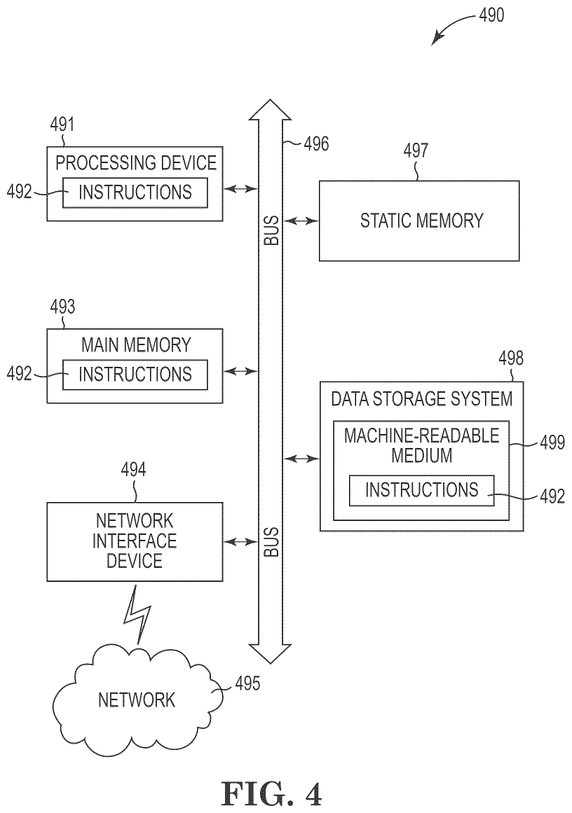

FIG. 4 illustrates an example machine of a computer system 490 within which a set of instructions, for causing the machine to perform any one or more of the methodologies discussed herein, can be executed. In some embodiments, the computer system 490 can correspond to a host system (e.g., the host 110 of FIG. 1) that includes, is coupled to, or utilizes a memory system (e.g., the memory device 120 of FIG. 1) or can be used to perform the operations of the PU controller (e.g., the PU controller 105 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 490 includes a processing device 491, a main memory 493 (e.g., read-only memory (ROM), flash memory, dynamic random access memory (DRAM) such as synchronous DRAM (SDRAM) or Rambus DRAM (RDRAM), etc.), a static memory 497 (e.g., flash memory, static random access memory (SRAM), etc.), and a data storage system 498, which communicate with each other via a bus 496.

Processing device 491 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 491 can also be one or more special-purpose processing devices such as an application specific integrated circuit (ASIC), a field programmable gate array (FPGA), a digital signal processor (DSP), network processor, or the like. The processing device 491 is configured to execute instructions 492 for performing the operations and steps discussed herein. The computer system 490 can further include a network interface device 494 to communicate over the network 495.

The data storage system 498 can include a machine-readable storage medium 499 (also known as a computer-readable medium) on which is stored one or more sets of instructions 492 or software embodying any one or more of the methodologies or functions described herein. The instructions 492 can also reside, completely or at least partially, within the main memory 493 and/or within the processing device 491 during execution thereof by the computer system 490, the main memory 493 and the processing device 491 also constituting machine-readable storage media.

In one embodiment, the instructions 492 include instructions to implement functionality corresponding to the PU controller 105 of FIG. 1. While the machine-readable storage medium 499 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Although specific embodiments have been illustrated and described herein, those of ordinary skill in the art will appreciate that an arrangement calculated to achieve the same results can be substituted for the specific embodiments shown. This disclosure is intended to cover adaptations or variations of various embodiments of the present disclosure. It is to be understood that the above description has been made in an illustrative fashion, and not a restrictive one. Combinations of the above embodiments, and other embodiments not specifically described herein will be apparent to those of skill in the art upon reviewing the above description. The scope of the various embodiments of the present disclosure includes other applications in which the above structures and methods are used. Therefore, the scope of various embodiments of the present disclosure should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus, comprising:
a plurality of banks of memory cells;
a bank controller coupled to the plurality of banks of memory cells;
a processing unit (PU) controller coupled to the plurality of banks of memory cells and comprising a PU;
wherein the bank controller is configured to provide data from the plurality of banks to the PU controller;
wherein the PU controller is configured to:
receive data from any of the plurality of banks; and
provide the data to the PU; and
wherein the PU is configured to perform a plurality of operations utilizing the data.

2. The apparatus of claim 1, wherein the PU controller is further configured to:
receive first data from a first bank of the plurality of banks of memory cells; and
provide the first data to the PU.

3. The apparatus of claim 2, wherein the PU controller is further configured to provide output data generated by the PU utilizing the first data to the first bank for storage.

4. The apparatus of claim 2, wherein the bank controller is further configured to provide second data from the second bank of memory cells, of the plurality of banks of memory cells, to the PU controller.

5. The apparatus of claim 4, wherein the PU controller is further configured to provide the second data to the PU subsequent to providing the first data to the PU.

6. The apparatus of claim 4, wherein the PU controller is further configured to provide output data generated by the PU utilizing the second data to the first bank for storage.

7. The apparatus of claim 6, wherein the PU controller is further configured to provide different output data generated by the PU utilizing the first data to the second bank for storage.

8. A method, comprising:
providing, by a bank controller, data from a bank of memory cells of a memory device to a processing unit (PU) controller;
receiving, by the PU controller, the data from the bank of memory cells, wherein the PU controller is coupled to the bank;
determining, by the PU controller, available PUs of a plurality of PUs;
providing, by the PU controller, the data to the available PUs; and
performing, by the available PUs, a plurality of operations utilizing the data.

9. The method of claim 8, wherein the plurality of PUs is coupled to the PU controller and further comprising providing the data externally, to the PU controller, to the available PUs.

10. The method of claim 8, further comprising storing the data received from the bank in registers of the PU controller.

11. The method of claim 10, wherein the PU controller includes the plurality of PUs and further comprising providing the data internally from the registers to the available PUs.

12. The method of claim 8, further comprising providing the data to the available PUs sequentially.

13. The method of claim 8, further comprising providing the data to the available PUs concurrently.

14. The method of claim 8, further comprising providing output data generated by each of the available PUs to the bank concurrently.

15. The method of claim 8, further comprising storing output data generated by each of the available PUs in output registers of the PU controller.

16. The method of claim 15, further comprising providing the output data stored in the output registers to the bank sequentially.

17. The method of claim 15, further comprising:
providing a first portion of the output data stored in the output registers to the bank; and
providing a second portion of the output data stored in the output registers to a system-on-chip (SOC) coupled to the memory device that includes the bank of memory cells, the PU controller, and the plurality of PUs.

18. An apparatus, comprising:
a plurality of banks of memory cells;
a bank controller;
a processing unit (PU) controller coupled to the plurality of banks of memory cells and comprising a plurality of PUs;
wherein the bank controller is configured to provide data from the plurality of banks to the PU controller;
wherein the PU controller is configured to:
receive the data from any of the plurality of banks; and
determine, by the PU controller, available PUs of a plurality of PUs; and
provide the data to the available PUs; and
wherein the available PUs are configured to perform a plurality of operations utilizing the data.

19. The apparatus of claim 18, wherein the PU controller is further configured to provide output data generated by the plurality of operations from the available PUs to the plurality of banks.

20. The apparatus of claim 19, wherein the PU controller is further configured to:
provide first data, from the data, received from a first bank from the plurality of banks to a first available PU from the available PUs;
perform a first plurality of operations utilizing the first data to generate first output data;
provide second data, from the data, received from a second bank from the plurality of banks to a second available PU from the available PUs;
perform a second plurality of operations utilizing the second data to generate second output data;
provide the first output data from the first available PU to the second bank; and
provide the second output data from the second available PU to the first bank.
